(19) United States
(12) Patent Application Publication
(10) Pub. No.: US 2013/0332376 A1
(43) Pub. Date: Dec. 12, 2013

(54) METHOD AND SYSTEM FOR DYNAMIC TEST COMPLIANCE IN A MULTI LEVEL SUPPLY CHAIN HIERARCHY

(71) Applicants: Pascal PILON, Montreal (CA); Philipe Desaulniers, Mont Saint-Hilaire (CA); Nicolas Roy, St-Lambert (CA)

(72) Inventors: Pascal PILON, Montreal (CA); Philipe Desaulniers, Mont Saint-Hilaire (CA); Nicolas Roy, St-Lambert (CA)

(21) Appl. No.: 13/494,092

(22) Filed: Jun. 12, 2012

(51) Int. Cl. G06Q 99/00

(52) U.S. Cl. 705/317

(57) ABSTRACT

The present relates to a method and system for performing dynamic test compliance in a multi level supply chain hierarchy. The method and system receive specifications for a type of component, allocate a unique identifier to a component corresponding to the type of component, execute a suite of tests on the component, and generate a compliance certificate for the component. The compliance certificate comprises the unique identifier of the component; and a compliance status, indicative of a compliance of the component. The compliance status is a function of the specifications, and of results of the suite of tests. The compliance certificates of components included in a product are further analyzed. For instance, the method and system determine which of the components included in a product have a compliance status set to non compliant. The multi level supply chain hierarchy comprises the OEM and a hierarchy of supply chain partners.

### TECHNICAL FIELD

The present disclosure relates to the field of test compliance in a multi level supply chain hierarchy; and more particularly to a dynamic management of the test compliance.

### BACKGROUND

Manufacturing processes have become more and more complex, involving multiple contributors for the production of a final product. The final product is generally composed of a large number of components, manufactured by the multiple contributors. Furthermore, a component manufactured by a contributor may include sub-components manufactured by another contributor.

One can refer to the notion of supply chain hierarchy, to represent the interactions between the multiple contributors for the production of a product. The supply chain hierarchy includes an Original Equipment Manufacturer (OEM), in charge of the production of the product. The OEM has tier 1 suppliers, which manufacture components included in the product. Then, the tier 1 suppliers may have tier 2 suppliers, which manufacture components included in their own components. Etc, from tier 1 to tier N suppliers, where a tier I supplier (I between 2 and N) manufactures components included in components manufactured by a tier I-1 supplier. This hierarchy, including the OEM and the various levels of tier suppliers, is referred to as a multi level supply chain hierarchy.

The OEM is responsible for the quality of the product. In particular, the OEM shall guarantee that the product is compliant with specifications for this product. However, the compliance of the product is dependant on the compliance of multiple components included in the product. And it is not a trivial task for an OEM, to determine that a specific component included in a product is compliant. The component has been manufactured (and usually tested) by a tier I supplier, with a more or less tight control by the OEM on the manufacturing/testing processes of the tier I supplier. Furthermore, taking into account the tier I supplier, not as a standalone supplier, but as a member of the multi level supply chain hierarchy, is even more complex. There is therefore a need for a method and system for dynamic test compliance in a multi level supply chain hierarchy.

### SUMMARY

The present disclosure relates to the field of test compliance in a multi level supply chain hierarchy; and more particularly to a dynamic management of the test compliance.

According to a first aspect, the present disclosure provides a method for performing dynamic test compliance in a multi level supply chain. For doing so, the method receives, at a tier I supplier system, specifications for a type of component. The method allocates, at the tier I supplier system, a unique identifier to a component corresponding to the type of component. The method executes, at the tier I supplier system, a suite of tests on the component. The method generates, at the tier I supplier system, a compliance certificate for the component comprising the unique identifier of the component, and a compliance status indicative of a compliance of the component. The compliance status is a function of the specifications and results of the suite of tests. And the method analyzes, at an OEM system, the compliance certificate of at least one component included in a product, using the unique identifier of the at least one component included in the product to identify the corresponding compliance certificate. The multi level supply chain hierarchy comprises the OEM and N levels of tier I suppliers, with N greater or equal to 1 and I varying from 1 to N.

According to a second aspect, the present disclosure provides a system for performing dynamic test compliance in a multi level supply chain. For doing so, the system comprises a tier I supplier system. The tier I supplier system receives specifications for a type of component; allocates a unique identifier to a component corresponding to the type of component; executes a suite of tests on the component; and generates a compliance certificate for the component comprising the unique identifier of the component and a compliance status indicative of a compliance of the component. The compliance status is a function of the specifications and results of the suite of tests. The system also comprises an OEM system. The OEM system analyzes the compliance certificate of at least one component included in a product, using the unique identifier of the at least one component included in the product to identify the corresponding compliance certificate. The multi level supply chain hierarchy comprises the OEM and N levels of tier I suppliers, with N greater or equal to 1 and I varying from 1 to N.

According to a third aspect, the compliance certificate comprises measurable properties corresponding to the specifications, and measured properties corresponding to the results of the suite of tests. Each measured property is associated to a corresponding measurable property.

According to a fourth aspect, the compliance status of the compliance certificate is generated as a function of a value of each measured property being within a set of values defined by the corresponding measurable property.

According to a fifth aspect, a measurable property comprises a target value and a tolerance threshold. And the set of values defined by the corresponding measurable property are a range of values between the target value minus the tolerance threshold, and the target value plus the tolerance threshold.

According to a sixth aspect, the compliance status of the compliance certificate is compliant when the value of each measured property is in a range of values between the target value minus the tolerance threshold, and the target value plus the tolerance threshold.

According to a seventh aspect, at least one measurable property is modified, and the compliance status of the compliance certificate is re-evaluated to take into account the modification to the measurable property.

According to an eighth aspect, the OEM manufactures products which may include components from at least one tier 1 supplier. And a tier I supplier manufactures components which may include components from at least one tier I+1 supplier.

According to a ninth aspect, the type of component comprises one of: a software, a hardware part, and a sub-system.

According to a tenth aspect, the compliance certificates of all the components included in a product are analyzed, to determine which components have a compliance certificate with a compliance status set to non compliant.

According to an eleventh aspect, statistical patterns are identified in compliance certificates of components included in defective products. And other products using components with similar statistical patterns in their compliance certificates are further identified.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a multi level supply chain hierarchy, according to a non-restrictive illustrative embodiment;

FIGS. 2A and 2B illustrate a multi level hierarchy of compliance certificates, according to a non-restrictive illustrative embodiment;

FIG. 3 illustrates a compliance certificate, according to a non-restrictive illustrative embodiment;

FIG. 4 illustrates a system for dynamic test compliance in a multi level supply chain hierarchy, according to a non-restrictive illustrative embodiment;

FIG. 5 illustrates a method for dynamic test compliance in a multi level supply chain hierarchy, according to a non-restrictive illustrative embodiment.

### DETAILED DESCRIPTION

The present disclosure relates to the field of test compliance in a multi level supply chain hierarchy; and more particularly to a dynamic management of the test compliance. A multi level supply chain hierarchy is an ecosystem of manufacturing partners, which collaborate via a hierarchy of manufacturing entities, to design and manufacture a product. The product is composed of a combination of software, hardware parts, and sub-systems. The components of the product are manufactured in the ecosystem of manufacturing partners. One important issue is to ensure a compliance of the product with specifications; and more specifically to have the capability to determine which specific sub-component of the product is responsible for the non-compliance of the product.

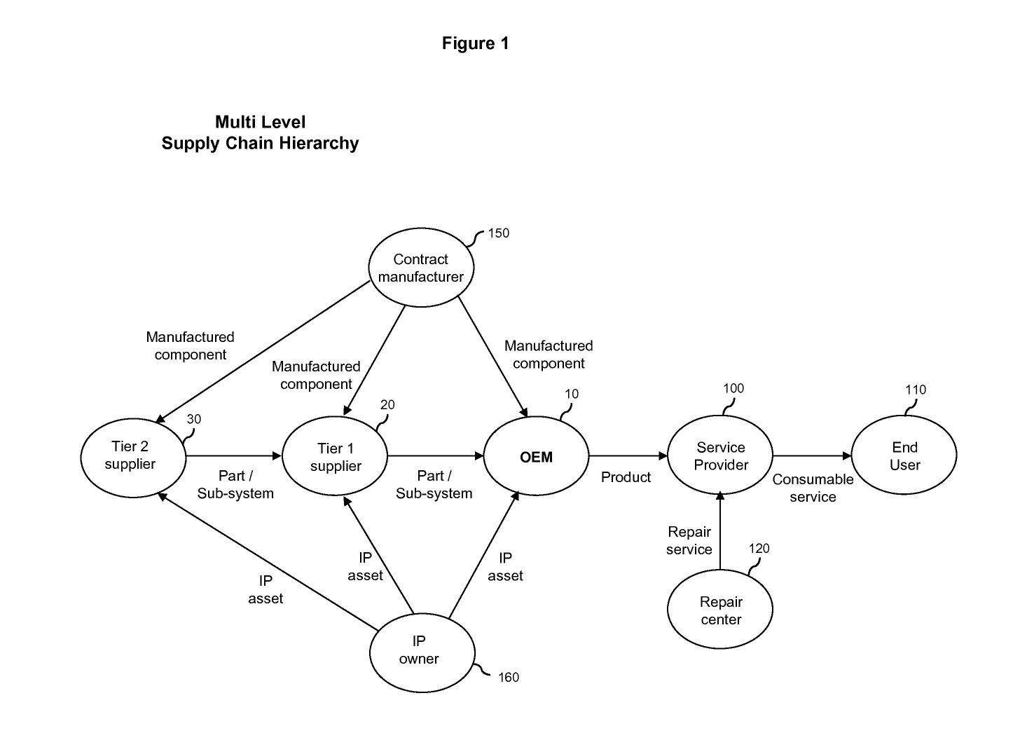

Referring now to FIG. 1, a multi level supply chain hierarchy will be described.

An Original Equipment Manufacturer (OEM) 10 designs and commercializes a product. The OEM is a direct supplier of a service provider 100, by selling the product to the service provider 100. The OEM may manufacture the entire product. The OEM may also assemble components manufactured by other suppliers, to build the product. And the OEM may perform a combination of manufacturing and assembling operations.

The product sold by the OEM 10 to the service provider 100 is further used by the service provider 100, to offer a consumable service to an end user 110. Alternatively, the OEM 10 may sell the product directly to end users 110, without an intermediate service provider 100. For example, a manufacturer of mobile phones may be considered as an OEM 10. The manufacturer of mobile phones may sell phones directly to end users 110, via physical and/or on-line stores. The manufacturer of mobile phones may also sell phones to a network operator (the service provider 100). In this latter case, the network operator makes the phones available to end users 110, as part of a mobile communication service. The phones may be given away to end users 110, and the end users 110 pay a monthly fee for the usage of the mobile communication service.

The service provider 100 may subcontract repair activities of defective products to a repair center 120. A product commercialized by the OEM 10 may be defective, and the defect may be detected at the service provider level 100, or at the end user level 110. Alternatively, the product commercialized by the OEM 10 may be fully operational. However, over time, it may become defective, due to an inappropriate usage by the end user 110, or to a defect in the conception of the product.

The product commercialized by the OEM 10 is composed of software, hardware parts, and sub-systems. In the context of a multi level supply chain environment, a tier 1 supplier 20 supplies software, and/or hardware parts, and/or sub-systems to the OEM 10. The supplied software, hardware parts, and sub-systems are integrated in the product commercialized by the OEM 10.

The components (hardware parts and sub-systems) which compose a product may be of one or several types, including: electrical components, optical components, electronic components, mechanical components, mechatronic components.

In the general case, a product is composed of several sub-systems. Each sub-system consists of hardware parts and/or software. A sub-system is designed to provide a specific set of functionalities. The assembly of the sub-systems of a product, and the interactions between the functionalities of these sub-systems, provides the global functionalities of the product. A product may also consist in the assembly of sub-system(s), and standalone hardware part(s).

For example, if the OEM 10 is a manufacturer of mobile phones, the product is a mobile phone. A first sub-system is a radio communication component, including a Radio Frequency (RF) hardware parts, and a RF communication software. A second sub-system is a central processing entity, including hardware parts (e.g. a micro-processor), and a software (e.g. an operating system). And a third sub-system is a display component, including hardware parts composing a screen, a dedicated micro-processor to control the screen, and a screen management software executed on the dedicated micro-processor. This simplified decomposition of a mobile phone in sub-systems is for illustration purposes only, and is not meant to be exhaustive. In this case, the tier 1 supplier 20 may manufacture the first sub-system; and another tier 1 supplier (not represented in FIG. 1) may manufacture the third sub-system. The notion of tier 1 supplier implies that they manufacture sub-systems, which are directly supplied to the OEM 10. The OEM 10 manufactures the second sub-system, and assembles the three sub-systems to build the product (the mobile phone).

Referring to the previous example, the first sub-system manufactured by the tier 1 supplier 20 may contain software, and/or hardware parts, and/or sub-systems manufactured by a tier 2 supplier 30. For example, some RF hardware parts of the first sub-system may be manufactured directly by the tier 1 supplier 20. And some RF hardware parts of the first sub-system may be provided by the tier 2 supplier 30. Generally speaking, the supply chain hierarchy comprises a hierarchy of level 1 to level N tier suppliers. A tier I supplier (supplier of level I, with I comprised between 1 and N−1 included) may integrate software, and/or hardware parts, and/or sub-systems from at least one tier I+1 (supplier of level I+1) supplier. And as already mentioned, the OEM 10 integrates software, and/or hardware parts, and/or sub-systems from at least one tier 1 supplier 20. There is no limit on the value of N, which varies from one implementation of a supply chain hierarchy to another. In FIG. 1, only two levels are represented for simplification purposes: tier 1 supplier 20, and tier 2 supplier 30. However, a tier 3 supplier, a tier 4 supplier, etc, may also be part of the supply chain hierarchy.

A tier I supplier may integrate software, and/or hardware parts, and/or sub-systems from more than one tier I+1 supplier. For instance, the tier 1 supplier 20 may integrate components from the tier 2 supplier 30, as well as from additional tier 2 suppliers (not represented in FIG. 1).

The OEM may be considered as a tier 0 supplier, with respect to its respective tier 1 supplier(s). From the perspective of the service provider 100, the OEM 10 may be considered as a tier 1 supplier providing a final product (instead of software, hardware parts, and sub-systems).

The OEM and some tier I suppliers often subcontract their manufacturing activities to a contract manufacturer 150. A single contract manufacturer 150 is represented in FIG. 1 (for simplification purposes) for the OEM 10, the tier 1 supplier 20, and the tier 2 supplier 30. However, each tier I supplier may have its own contract manufacturer, or possibly several different contract manufacturers.

The OEM and some tier I suppliers often depend on Intellectual Property (IP) assets owned by an IP owner 160. A single IP owner 160 is represented in FIG. 1 (for simplification purposes) for the OEM 10, the tier 1 supplier 20, and the tier 2 supplier 30. However, each tier I supplier may depend on its own IP owner, or possibly several different IP owners. An IP asset defines Intellectual Property rights associated to a component (hardware part, sub-system, software, product)—or to a portion of a component—manufactured by a tier I supplier (including the OEM as a tier 0 supplier). Usually, for each instance of the component manufactured (and/or sold) by the tier I supplier, a licensing fee shall be paid to the IP owner. A tier I supplier may also play the role of an IP owner with regards to upper level tier suppliers. In particular, OEMs usually own IP assets, which can be enforced to tier 1 suppliers, tier 2 suppliers, etc.

The OEM plays a specific role in the manufacturing supply chain: it is responsible of the compliance of the product it manufactures, with respect to specifications of this product. The specifications define how the product shall operate, by means of measureable properties of the product. The measurable properties are measured by means of a suite of tests performed by the OEM. The result of a test consists in a measured property (the measure of the property by performing the test). Based on the value of the measured property, the corresponding test is declared as passed or failed. The test is passed if the measured property is within a pre-defined set of values, as per the specifications. If all the tests associated to the specifications of a product are passed, the product is compliant with the specifications. A compliance certificate is generated, and associated to the specific instance of the product which has been tested.

However, if the product is declared non-compliant, it is not sufficient to precisely identify the component(s) responsible for the non-compliance. As described previously, the product is composed of software, and/or hardware parts, and/or sub-systems provided by at least one tier 1 supplier. Then, the sub-systems provided by the at least one tier 1 supplier are themselves composed of software, and/or hardware parts, and/or sub-systems provided by at least one tier 2 supplier. And the same principle applies, up to the tier N supplier of the manufacturing supply chain.

Generally speaking, a tier I supplier (I from 0 to N−1) shall not have to test the components (software, hardware parts, sub-systems) provided by a tier I+1 supplier. The tier I+1 supplier shall guarantee that the components provided to the tier I supplier are compliant (operate in accordance with their specifications). A tier I provider shall test the components (software, hardware parts, sub-systems) that it manufactures at its level. And it shall guarantee that a component manufactured at its level, and delivered to a tier I−1 supplier is compliant (operates in accordance with its specifications).

Thus, an object of the present method and system is to generate a compliance certificate for each component (software, hardware part, sub-system, or product) manufactured at a tier I level (I from 0 to N). The compliance certificate is representative of the success or failure of a suite of tests passed on the component, the tests being representative of the specifications of the component. The hierarchy of tier I suppliers is mirrored by a hierarchy of compliance certificates, from level 0 to N. A compliance certificate at level 0 (OEM level) may depend on compliance certificates from level 1 (tier 1 suppliers). A compliance certificate at level 1 (tier 1 supplier) may depend on compliance certificates from level 2 (tier 2 suppliers). Etc.

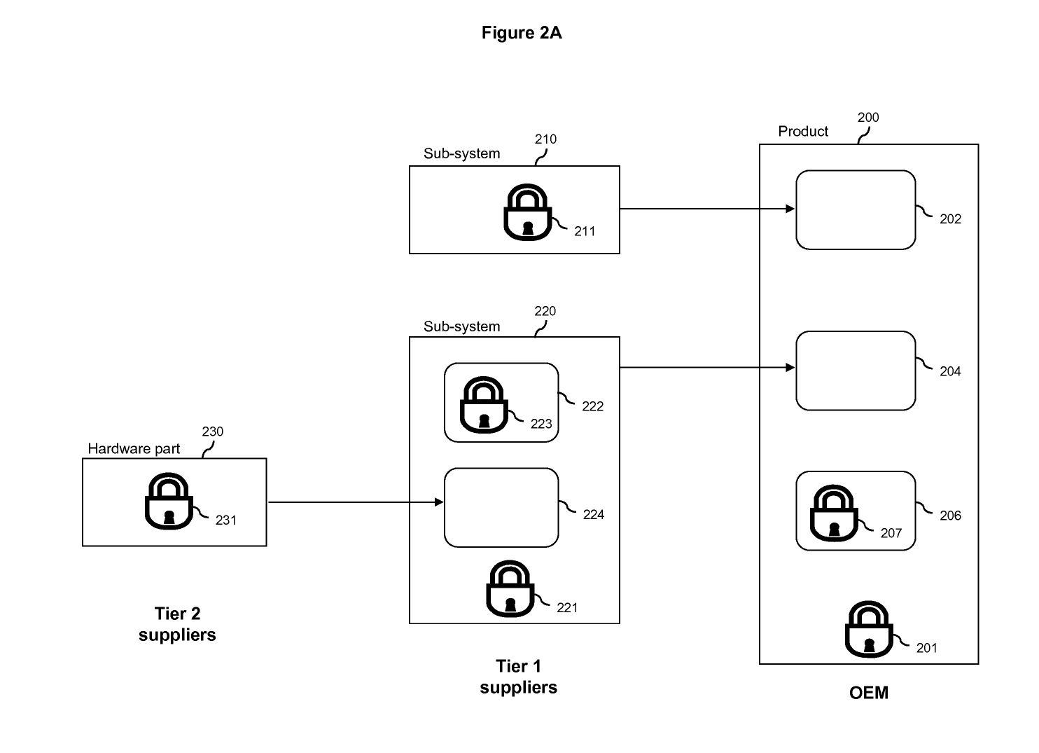

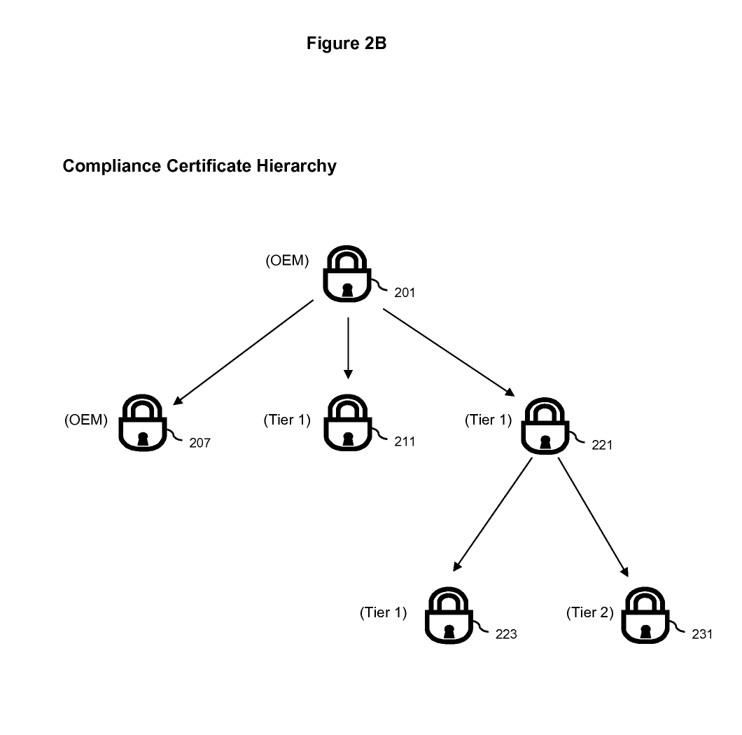

Referring now to FIG. 2A, a multi level hierarchy of compliance certificates will be described.

A product 200 manufactured by an OEM is represented in FIG. 2A. The product 200 is composed of three sub-components. A first sub-component 202 is manufactured by a first tier 1 supplier. A second sub-component 204 is manufactured by a second tier 1 supplier. And a third sub-component 206 is manufactured by the OEM.

The first tier 1 supplier manufactures a component 210, corresponding to sub-component 202 of product 200.

The second tier 1 supplier manufactures a component 220, corresponding to sub-component 204 of product 200. The component 220 is composed of two sub-components. A first sub-component 222 is manufactured by the tier 1 provider. And a second sub-component 224 is manufacturer by a tier 2 supplier.

The tier 2 supplier manufactures a component 230, corresponding to sub-component 224 of component 220.

At the tier 2 suppliers level, a compliance certificate 231 is generated, based on test results of a suite of tests applied to sub-component 230.

At the tier 1 suppliers level, a compliance certificate 211 is generated, based on test results of a suite of tests applied to component 210. A compliance certificate 223 is generated, based on test results of a suite of tests applied to sub-component 222. And a compliance certificate 221 is generated, based on test results of a suite of tests applied to component 220.

At the OEM level, a compliance certificate 207 is generated, based on test results of a suite of tests applied to sub-component 206. And a compliance certificate 201 is generated, based on test results of a suite of tests applied to component 200.

The components and sub-components introduced in FIG. 2A may consist in the following. Component 200 is a product manufactured by the OEM. Sub-component 202 is a sub-system manufactured by a first tier 1 supplier (210). Sub-component 204 is a sub-system manufactured by a second tier 1 supplier (220). Sub-component 206 is a sub-system manufactured by the OEM. The sub-system 220 is composed of a sub-system 222 manufactured by the second tier 1 supplier, and of a hardware part 224, manufactured by a tier 2 supplier (230).

FIG. 2B illustrates the hierarchy of compliance certificates defined with reference to FIG. 2A. This hierarchy of certificates may be used in different ways, to optimize the manufacturing supply chain operations, and to guarantee quality along the manufacturing supply chain.

For example, at the OEM level, if a sub-system 210 or 220 provided by a tier 1 supplier has a compliance certificate indicating that the sub-system is not compliant, this sub-system is refused and not integrated in the product 200. This allows the OEM to rapidly detect that a tier 1 provider has provided (by error or intentionally) a non-compliant sub-system. In another example, the second tier 1 supplier may have integrated in sub-system 220 (by error or intentionally) a hardware part 224 from the tier 2 supplier, with a compliance certificate indicating that the hardware part is not compliant. However, the suite of tests defined for sub-system 220 may pass, and a compliance certificate 221 indicating that the sub-system is compliant may be generated. In this example, the non compliance of the hardware part 224 may only be detected, when performing the suite of tests associated to the product 200 (in relation to compliance certificate 201). By analyzing the hierarchy of compliance certificates, the OEM is capable of detecting that hardware part 224 is not compliant, and to refuse to integrate sub-system 220 in the product 200. Other examples will be provided later in the description, to illustrate how a sub-component with a compliance certificate indicating that it is compliant, may be pro-actively detected as having the potential to induce a failure in the operations of product 200.

For simplification purposes, only two levels of tier suppliers have been represented in FIG. 2A. However, the notion of a hierarchy of compliance certificates may be extended to any number of levels of tier suppliers.

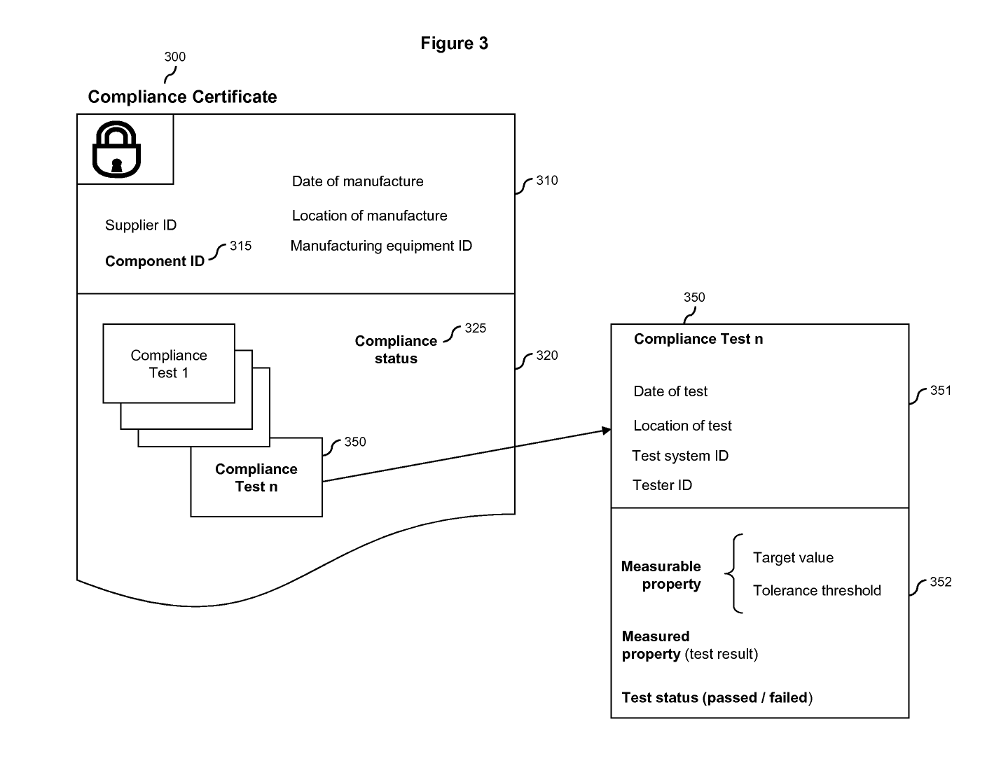

Referring now to FIG. 3, a compliance certificate will be described.

A compliance certificate 300 is illustrated in FIG. 3. The compliance certificate 300 is generated after a suite of tests is performed on an instance of a specific type of component (e.g. software, hardware part, sub-system, product, etc). The compliance certificate 300 may be re-issued, if the suite of tests is re-applied later.

A first section 310 of the compliance certificate 300 contains information related to the component. This information includes: a supplier ID, to uniquely identify the supplier which produced the component. The component may be composed of sub-components produced by other suppliers. However, the supplier ID identifies the supplier which is held responsible for the quality of the component to which the compliance certificate 300 is attached.

The first section 310 also contains a component ID 315. The component ID 315 uniquely identifies the component to which the compliance certificate 300 is attached. In the manufacturing industry, each component produced is allocated a serial number. This serial number uniquely identifies the produced component, at least at the level of the supplier which produced the component. The serial number may possibly uniquely identify the produced component at a higher level, for instance among all suppliers of the same industry (e.g. electronics, aeronautics, automotive, etc). Thus, the component ID 315 may be a combination of the serial number and the supplier ID, to uniquely identify the produced component.

Additional information may be present in the first section 310. This includes the date of manufacture of the component, and the location of manufacture of the component (in the case where the component may be produced in several locations). The information may also include one (or several) manufacturing equipment ID(s), to identify the manufacturing equipment(s) involved in the production of the component at the supplier. As already mentioned, the terms manufacture/manufacturing shall be interpreted in a broad sense. The supplier of the component may effectively perform manufacturing operations, or may only assemble sub-components provided by other suppliers, or may provide the software associated to a hardware part, etc.

The first section 310 of the compliance certificate 300 may only contain the component ID 315. The additional information (supplier ID, date of manufacture, location of manufacture, manufacturing equipment ID) may be stored in a dedicated information system, related to the manufacturing process. In this case, the component ID 315 may be used as a reference, to link this additional information to the corresponding compliance certificate 300.

A second section 320 of the compliance certificate 300 contains information related to the suites of tests performed on the component. For each test performed on the component, a corresponding compliance test data set is included in the second section 320 of the compliance certificate 300. For illustration purposes, data sets for compliance tests 1 to n are illustrated in FIG. 3.

The data set 350 for compliance test n is detailed in FIG. 3, to illustrate the information present in a compliance test data set. A first section 351 of the compliance test data set 350 contains information related to the testing environment. Such information include, for example, a date of test, a location of test (in the case where the component may be tested in several locations), a test system ID (to identify precisely the test system used to perform the test), and a tester ID (to identify precisely the person(s) responsible for the execution of the test). This type of information may be useful to identify patterns related to a specific test. For example, it may be discovered that a given compliance test I is a false positive for a set of components: compliance test I is recorded as passed in the corresponding compliance certificates 300, but the components are later determined as non-compliant. A pattern may be identified by analyzing the compliance certificates: the false positives occur for a certain combination of dates of test/test system IDs/tester IDs. All the components with a compliance certificate 300 showing this pattern can be easily identified. And the proper action may be taken for these components (e.g. discard or retest the components, discard or retest sub-systems and/or products that use these components, etc).

A second section 352 of the compliance test data set 350 contains information related to the test itself. This information consists in a measurable property, and a measured property. The measurable property represents a specification of the component: how the component shall operate under specific conditions. And the measured property represents the result of a test performed on the component under the specific conditions.

In an embodiment of the present disclosure, the measurable property consists of a target value, and a tolerance threshold. Under the specific conditions corresponding to the test, the measurable property shall have the target value, with a tolerance equal to the tolerance. The measured property (test result) is compared to the target value. If the measured property is within a range of values defined by the target value and the tolerance threshold (a range of values between the target value minus the tolerance threshold and the target value plus the tolerance threshold), the test is passed. Otherwise, the test is failed. The second section 352 contains a test status, indicative of whether the test passed or failed, along with the measurable and measured property values.

The second section 352 may also contain the specific conditions related to a given compliance test (the conditions to apply to the component to obtain a measurable property in the range of target value corrected by the tolerance threshold). Alternatively, the specific conditions may be stored in a dedicated test information system; and a cross reference may be used between these conditions and the related compliance test data set 350. The specific conditions may, or may not, include operational conditions of the component (as illustrated in the following example).

To illustrate the notion of compliance test, we consider the case where the component is a Radio Frequency (RF) component, with an analog input signal and a digital output signal. In a compliance test related to the RF component, the measurable property consists in the absolute value of the digital output signal (with a target value and a tolerance threshold). The measured property is the measured absolute value of the digital output signal, measured via a dedicated test equipment. The specific conditions include the indication that the absolute value of the digital output signal shall be measured. If no operational condition is specified, the measurable property is measured by the test equipment under no particular operational conditions of the RF component. If an operational condition is specified, the measurable property is measured by the test equipment under the specified operational condition of the RF component. An example of an operational condition consists in specifying that the measure shall be performed, when the amplitude of the input analog signal is below a specific value.

Referring back to the second section 320 of the compliance certificate 300, it contains a compliance status 325, indicating if the component corresponding to the compliance certificate is compliant or not. The compliance status of the compliance certificate is generated as a function of a value of each measured property (test result) being within a set of values defined by the corresponding measurable property.

For example, in the aforementioned case where the measurable properties comprise a target value and a tolerance threshold, the compliance status of the compliance certificate is generated as a function of the test statuses (passed/failed) of each of the compliance tests 1 to n. Each test status is indicative of the value of a measured property being in a range of values between the target value minus the tolerance threshold and the target value plus the tolerance threshold. If all test statuses are set to passed, the compliance status 325 indicates a compliance of the component. If one test status is set to failed, the compliance status 325 indicates a non-compliance of the component. However, a more complex algorithm may be used, to determine the value of the compliance status 325 of the compliance certificate 300 as a function of the test statuses. The compliance status 325 may also be expressed as a percentage of compliance, which depends on the number of test statuses set to passed (a weighting factor for each test status may also be used in this case).

The compliance of a component (the compliance status of its compliance certificate) may be represented by equations as follows. We consider that n compliance tests have been defined in relation to the compliance certificate of the component:

Certificate_compliance_status(component)=Σᵢ₌₁ⁱ⁼ⁿcomponent_test_status(i) [1]

Where component_test_status(i) is the test status of compliance test i for the component; and is a function F of measured_property and measurable_property for test i:

component_test_status(i)=F(measured_property(i), measurable_property(i)) [2]

For instance, when a target_value and a tolerance_threshold are used for each compliance test i:

component_test_status(i)=passed if target_value(i)−tolerance_threshold(i)<measured_property(i)<target_value(i)+tolerance_threshold(i); failed otherwise [3]

Alternatively, the compliance of a component may be defined as a combination of the compliance of its sub-components, and the test statuses of its own compliance tests. It may be represented by the following equation.

Certificate_compliance_status(component)=Σᵢ₌₁ⁱ⁼ⁿcomponent_test_status(i)+ΣCertificate_compliance_status(sub_components) [4]

For instance, referring to sub-system 220 in FIG. 2A, its compliance is defined as:

Certificate_compliance_status(221)=Σᵢ₌₁ⁱ⁼ⁿsub-system_{—}220_test_status(i)+Certificate_compliance_status(223)+Certificate_compliance_status(231)

The compliance certificate 300 represented in FIG. 3 is for illustration purposes only. Some information may be omitted, and other information may be added, without changing the scope of the present disclosure.

The specific implementation of a compliance certificate is out of the scope of the present disclosure. A possible implementation may consist in a file, containing the information related to the compliance certificate in a pre-determined format (e.g. XML format). Such a file may be generated on a computing device, using a dedicated software to generate the file. The dedicated software may interact with other computing devices/software programs, including databases, to collect the information related to the compliance certificate, and to integrate the information in the file. The completed file may be further transferred to other computing devices, including databases, to be further processed/analyzed by means of dedicated software programs. The further processing/analysis include the monitoring of the compliance status of the compliance certificate. The file is considered completed when the compliance status of the compliance certificate has been determined.

The compliance certificate may include security mechanisms, to avoid the modification of the compliance certificate after the generation of the compliance status. This is to avoid that a compliance certificate, with a compliance status set to non compliant, may be modified. The modification may be performed to pretend that the component associated to the compliance certificate is compliant, while it is not in reality. However, the security mechanisms shall include the possibility to re-issue the compliance certificate under pre-determined circumstances. For instance, if the specifications have changed, the compliance certificate may be re-issued, to generate an updated compliance status, based on updated test results of the compliance tests (taking into account the new specifications).

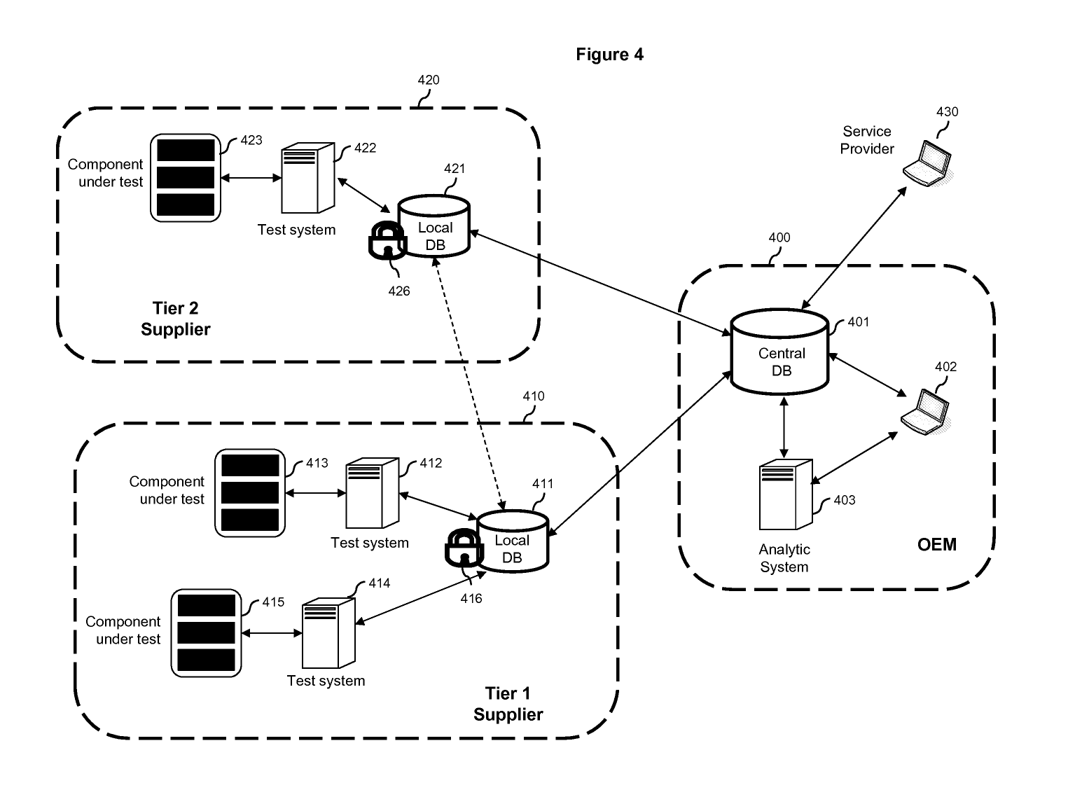

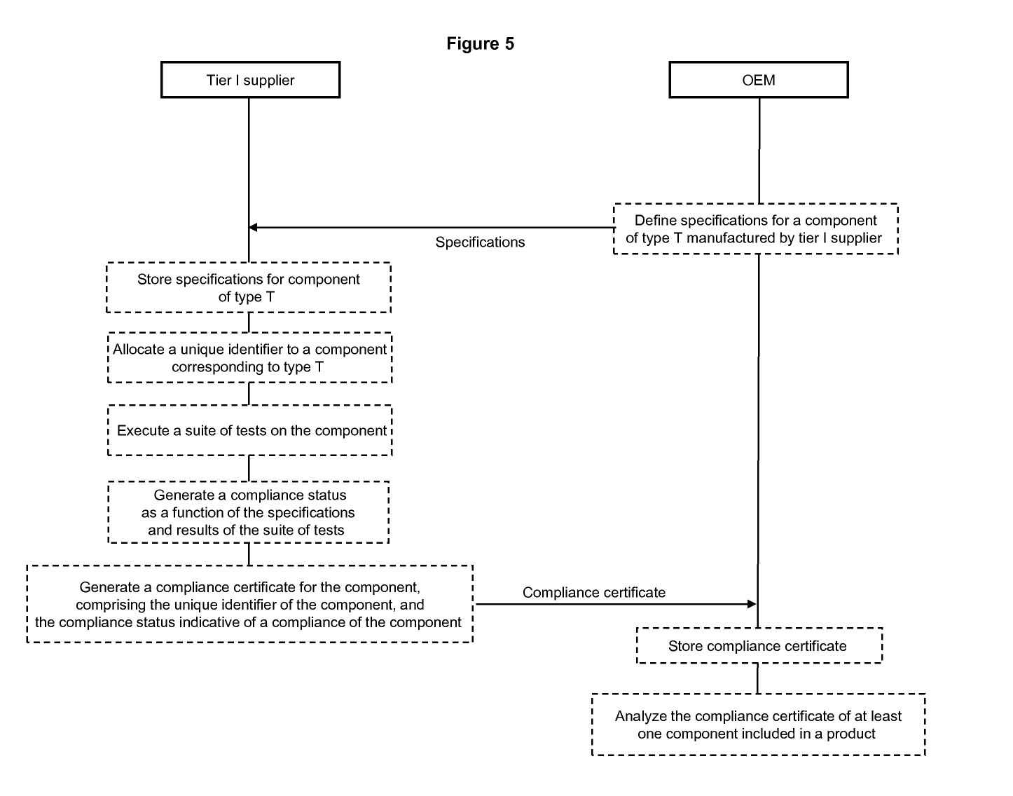

Referring now to FIGS. 4 and 5 concurrently, a system and method for dynamic test compliance in a multi level supply chain hierarchy will be described.

An OEM system 400 is represented in FIG. 4. The OEM system 400 comprises a central database 401, an end user processing terminal 402, and an analytic system 403.

A first tier I supplier system is represented in FIG. 4: the tier 1 supplier system 410. The tier 1 supplier system 410 comprises a local database 411, a test system 412, and a component under test 413. It also comprises a second test system 414, and a second component under test 415.

A second tier I supplier system is represented in FIG. 4: the tier 2 supplier system 420. The tier 2 supplier system 420 comprises a local database 421, a test system 422, and a component under test 423.

The supply chain hierarchy illustrated in FIG. 4 determines the following relationships between the OEM system 400, the tier 1 supplier 410, and the tier 2 supplier 420. A type of product is manufactured (not represented in FIG. 4) at the OEM system 400. At least one type of component included in this type of product is manufactured (not represented in FIG. 4) at the tier 1 supplier system 410. The type of component manufactured at the tier 1 supplier system 410 includes at least one type of component manufactured (not represented in FIG. 4) at the tier 2 supplier system 420. The manufacturing capabilities of the OEM, the tier 1 supplier, and the tier 2 supplier, are not represented in FIG. 4 for simplification purposes.

The notion of type of product for the OEM is introduced to take into account the fact that the OEM may manufacture several types of product. For each type of product, the OEM produces a number of products (instances of the type of product). Similarly, the notion of type of component for a tier I (e.g. 1 or 2) supplier is introduced to take into account the fact that the tier I supplier may manufacture several types of components. For each type of component, the tier I supplier produces a number of components (instances of the type of component).

The tier 1 supplier system 410 receives specifications for a type T1 of component. The specifications for this type T1 of component are defined at the OEM system 400, and sent to the tier 1 supplier system 410. For instance, the specifications are defined by an end user via the processing terminal 402, stored in the central database 401 of the OEM system 400, and transferred to the local database 411 of the tier 1 supplier system 410.

The test system 412 of the tier 1 supplier system 410 performs a suite of tests on a component under test 413. The component under test 413 corresponds to the type T1 of component. A unique identifier is allocated to the component under test 413 (as already mentioned, the unique identifier may consist of a serial number of the component, optionally combined with a unique identifier of the tier 1 supplier). The specifications stored in the local database 411 contain information used for the execution of the suite of tests. For instance, the specifications contain the list of compliance tests 1 to n (as illustrated in FIG. 3) to be performed. And for each specific compliance test, the specifications contain the measurable property (as illustrated in FIG. 3), e.g. the target value and the tolerance threshold. The execution of a compliance test may be fully automated: a configuration file based on the specifications is used by the test system 412 to perform the compliance test on the component under test 413. Alternatively, a tester may need to configure the test system 412, based on the specifications, to execute the compliance test. Test results (the measured property as illustrated in FIG. 3) for each test of the suite of test are collected and memorized by the test system 412.

The suite of tests may be executed by several test systems. For instance, as illustrated in FIG. 4, some of the compliance tests may be executed by test system 412, and some of the compliance tests may be executed by test system 414. In this case, the component under test 415 is the same as the component under test 413. Then, each test system (412 and 414) generates the test results (the measured properties) for the compliance tests for which it is responsible.

A compliance certificate 416 for the component under test 413 is generated by the tier 1 supplier system 410. For simplification purposes, we consider that the compliance certificate 416 is generated and stored at the local database 411. Alternatively, a dedicated computing system (not represented in FIG. 4) may be in charge of generating the compliance certificate 416, based on information collected form the local database 411, and form the test systems 412 (and 414). In any case, the compliance certificate 416 is stored at the local database 411.

The compliance certificate 416 comprises the information illustrated in FIG. 3. This information is collected from various components of the tier 1 supplier system 410 (e.g. test systems 412 and 414, the local database 411, the component under test 413, and possibly other entities not represented in FIG. 4 for simplification purposes). In particular, the compliance certificate 416 comprises the unique identifier of the component under test 413, and a compliance status indicative of the compliance of the component under test 413. As mentioned previously in relation to FIG. 3, the compliance status is a function of the specifications and the results of the suite of tests. Further, as illustrated in FIG. 3, the compliance certificate may comprise measurable properties corresponding to the specifications, and measured properties corresponding to the results of the suite of tests. And the compliance status of the compliance certificate may be a function of a value of each measured property being within a set of values defined by the corresponding measurable property.

The compliance certificate 416 may be permanently stored in the local database 411. In this case, the OEM system 400 retrieves the information of the compliance certificate 416, when the OEM system 400 needs to analyze the information of the compliance certificate 416. Alternatively, the compliance certificate 416 may be temporarily stored in the local database 411. When all the information of the compliance certificate 416 is collected, it is transferred to the central database 401 of the OEM system 400, and removed from the local database 411. In still another alternative, the compliance certificate 416 may be stored in both the local database 411 and the central database 401 (the compliance certificate is not removed from the local database 411 after its transfer to the central database 401).

A service provider may also collect and store compliance certificates corresponding to products supplied by one or several OEMs to the service provider. By doing so, the service provider centralizes information related to the compliance and the quality of various products supplied by various OEMs. This information may then be used to analyze and compare the performances of several OEMs selling products to the service provider.

The generation of a compliance certificate 426, for a component under test 423, at the tier 2 supplier system 420, is similar to the generation of the compliance certificate 416 at the tier 1 supplier system 410. However, there are some differences, related to the fact that the tier 2 supplier (420) manufactures a component (423) which is included in a component (413) manufactured by the tier 1 supplier (410).

The tier 2 supplier system 420 receives specifications for a type T2 of component. The specifications for this type T2 of component are defined at the OEM system 400, and sent to the tier 2 supplier system 420. For instance, the specifications are defined by an end user via the processing terminal 402, stored in the central database 401 of the OEM system 400, and transferred to the local database 421 of the tier 2 supplier system 421. Alternatively, the tier 1 supplier may be responsible for the specifications of the type T2 of component (since this type of component T2 is included in a type of component T1 manufactured by the tier 1 supplier). In this case, the specifications are defined at the tier 1 supplier system 410, stored in the local database 411 of the tier 1 supplier system 410, and transferred to the local database 421 of the tier 2 supplier system 421.

The test system 422 of the tier 2 supplier system 420 performs a suite of tests on the component under test 423. The component under test 423 corresponds to the type T2 of component. A unique identifier is allocated to the component under test 423. The specifications stored in the local database 421 contain information used for the execution of the suite of tests. For instance, the specifications contain the list of compliance tests 1 to n (as illustrated in FIG. 3) to be performed. And for each specific compliance test, the specifications contain the measurable property (as illustrated in FIG. 3), e.g. the target value and the tolerance threshold. Test results (the measured property as illustrated in FIG. 3) for each test of the suite of test are collected and memorized by the test system 422.

The compliance certificate 426 for the component under test 423 is generated by the tier 2 supplier system 420. For simplification purposes, we consider that the compliance certificate 426 is generated and stored at the local database 421.

The compliance certificate 426 comprises the information illustrated in FIG. 3. This information is collected from various components of the tier 2 supplier system 420 (e.g. the test system 422, the local database 421, the component under test 423, and possibly other entities not represented in FIG. 4 for simplification purposes). In particular, the compliance certificate 426 comprises the unique identifier of the component under test 423, and a compliance status indicative of the compliance of the component under test 423. The generation of the compliance status for the compliance certificate 426 (tier 2 supplier) is similar to the generation of the compliance status for the compliance certificate 416 (tier 1 supplier).

As previously described in relation to compliance certificate 416 (tier 1 supplier), the compliance certificate 426 (tier 2 supplier) may be permanently stored in the local database 421 (tier 2 supplier) exclusively, in the central database 401 (OEM) exclusively, or both in the local database 421 and the central database 401. Additionally, the compliance certificate 426 may be used by the tier 1 supplier system 410. For this purpose, a copy of the compliance certificate 426 may be transferred to the tier 1 supplier system 410 (and may be stored in its local database 411). For instance, before incorporating a component of type T2 (manufactured by the tier 2 supplier) in a component of type T1 (manufactured by the tier 1 supplier), the compliance certificate 426 corresponding to the component of type T2 may be checked (at the tier 1 supplier system 410). If the compliance status of the compliance certificate 426 indicates that the corresponding component is not compliant, this corresponding component is refused by the tier 1 supplier. The unique identifier of the component of type T2 (e.g. its serial number) is used to identify the corresponding compliance certificate 426 (the unique identifier of the component is stored in the compliance certificate 426).

In one embodiment of the present disclosure, the OEM system 400 analyzes compliance certificates of several components included in a product, using the unique identifiers of the several components included in the product to identify the corresponding compliance certificates.

As explained previously, the compliance certificates generated by the various tier I (e.g. tier 1 and tier 2) suppliers may be permanently stored in the central database 401 of the OEM system 400. In this case, the OEM system 400 has direct access (for analysis purposes) to the compliance certificates of several components included in a product. Alternatively, some of the certificates may be permanently stored in local databases (e.g. 411 and 421) of the tier I suppliers, in which case they are transferred from the local databases (e.g. 411 and 421) to the central database 401 for analysis purposes.

A product manufactured by the OEM may comprise components manufactured by the OEM itself, components manufactured by a tier 1 supplier, components manufactured by a tier 2 supplier, etc. For a specific product, the OEM has a list of components included in the product, with a unique identifier (e.g. a serial number) for each component. The list usually also includes a (unique) identification of the supplier (tier I supplier) of the component; with additional optional information such as the location of manufacture, the date of manufacture, an identification of the manufacturing equipment (as illustrated in FIG. 3, this type of information may also be appended to the compliance certificate). The list may be stored in the central database 401. The generation and management of such a list of components (and their unique identifiers) included in a product is out of the scope of the present disclosure. However, the generation and management of such a list of components are well known in the art of supply chain management. Having the unique identifier of each component included in the product, the OEM system 400 is capable of collecting the corresponding compliance certificates (since each compliance certificate includes the unique identifier of the corresponding component).

For example, the analysis of the compliance certificate of at least one component included in a product is performed by the analytic system 403. For this purpose, the analytic system 403 collects the relevant compliance certificate(s) from the central database 401. In a first implementation, all the compliance certificates generated at the various levels of the supply chain are pushed in the central database 401. And thus, the relevant compliance certificates are present in the central database 401. In another implementation, some compliance certificates may be stored in the local databases (e.g. 411 and 421) of tier I suppliers. In this case, the compliance certificates not available at the OEM system 400 are retrieved from the appropriate local databases (e.g. 411 and 421).

The type of analysis performed on the compliance certificates will be further detailed later in the description. On example consists in analyzing the compliance certificates of all the components of a product, which is not operating properly; to determine if a component with a compliance certificate indicating that the component is not compliant, has been incorporated (by error or intentionally) in the product. As a matter of fact, the OEM does not necessarily have a control on all the components included in a product. For example, the tier 1 supplier (410) may have incorporated a non compliant component of type 2 (manufactured by the tier 2 supplier 420), in a component of type T1 (manufactured by the tier 1 supplier 410), with no means for the OEM to detect/prevent it. The aforementioned analysis allows the OEM to detect the component which is not compliant in the product. The OEM may also pro-actively analyze the compliance certificates of all the components included in a product, to detect any non compliant component, before performing integration tests on the product, or delivering the product to a service provider.

The compliance of a product under the responsibility of an OEM is a combination of: the compliance certificate of the product (more specifically of the compliance status of the compliance certificate of the product), and the compliance certificates of all the components included in the product (more specifically of the compliance statuses of the compliance certificates of all the components included in the product).

The compliance of a product may be represented by an equation as follows.

Compliance(product)=Certificate_compliance_status(product)+ΣCertificate_compliance_status(components) [5]

where Certificate_compliance_status(product/components) is defined by equation [1].
For instance, referring to FIG. 2A, Compliance(200)=Certificate_compliance_status(201)+Certificate_compliance_status(207)+Certificate_compliance_status(211)+Certificate_compliance_status(221)+Certificate_compliance_status(223)+Certificate_compliance_status(231).

The type of analysis performed by the analytic system 403 on compliance certificates related to a product may be controlled by an end user processing terminal 402. The results of the analysis performed by the analytic system 403 may be stored in the central database 401. The stored results of the analysis may be available for consultation, from an end user processing terminal 402 at the OEM system, and also from an end user processing terminal 430 at the service provider. The service provider is the entity which purchases the product from the OEM.

Although a system with a hierarchy of two levels of tier suppliers (tier 1 and tier 2) has been represented in FIG. 4, additional levels (tier 3 suppliers, tier 4 suppliers, etc) may be added, without changing the scope of the present disclosure.

As illustrated in FIG. 2A, a component manufactured by a tier I supplier may include sub-components manufactured by tier I+1 suppliers, as well as sub-components manufactured by the tier I supplier itself. In this case, the compliance certificate of a sub-component manufactured by the tier I supplier itself is generated by the tier I supplier, based on a suite of tests performed by the tier I supplier.

As illustrated in FIG. 1, a contract manufacturer may be considered as a tier 1 supplier, with respect to an OEM; and as a tier I+1 supplier with respect to a tier I supplier. In this case, the manufactured component produced by the contract manufacturer is the sub-component included in a product/component produced by the OEM/tier I supplier respectively. The manufactured component has specifications, is tested by a suite of tests, and has a corresponding compliance certificate.

In a particular embodiment, a tier I supplier may have the responsibility to define the specifications of a component, in place of the OEM.

In another particular embodiment, a tier I supplier may delegate to a third party the execution of a suite of tests on a component. In this context, the infrastructure to generate the compliance certificate for this component, as described previously, may be split between the tier I supplier and the third party. However, this particular embodiment is still compliant within the scope of the present disclosure.

Also, in some circumstances, a tier I supplier may be considered as an OEM. In this case, a component manufactured by the tier I supplier may be considered as a product. The component may include sub-components manufactured by tier I+1 suppliers, which themselves include sub-components manufactured by tier I+2 suppliers, etc. The present method and system applies to the tier I supplier considered as an OEM, with tier I+1 suppliers considered as tier 1 suppliers, tier i+2 suppliers considered as tier 2 suppliers, etc. This may happen when the tier I supplier is responsible of a critical component (which is considered as a product), and/or when the OEM has a good trust relationship with the tier I supplier, and delegates the responsibility of the compliance of a component (considered as a product) to the tier I supplier.

Additionally, the OEM may be considered as a tier 1 supplier with respect to the service provider. Indeed, the service provider may define the specifications for the product manufactured by the OEM. And the OEM may generate a compliance certificate for the product, based on a suite of tests performed on the product, according to the specifications provided by the service provider. The suite of tests performed on the product by the OEM may be considered as integration tests. While the suite of tests performed by the tier I suppliers on the components of the product may be considered as unitary tests. The unitary tests may be successful, resulting in compliance certificates with a compliant status for the components. However, the integration tests may fail, resulting in a compliance certificate with a non-compliant status for the product. In this case, the analytic system 403 may be used, to analyze the compliance certificates, in order to determine patterns which may explain this situation. For instance, such patterns may include that, for compliance certificates of a specific type component, a measured property is too far from the associated target value (while still within the tolerance threshold).

The specifications, for a specific type of component manufactured by a tier I supplier, are specified in real time; and distributed in real time along the multi level supply chain hierarchy. For instance, the central database 401 of the OEM is updated in real time with specifications defined via an end user processing terminal 402 at the OEM. Then, the specifications are transferred in real time from the central database 401 to the local database (e.g. 411 or 421) of the tier I supplier. Alternatively, the specifications are transferred in real time from the central database 401 to the local database 411 of a relevant tier 1 supplier, from there to the local database 421 of a relevant tier 2 supplier, up to the local database of the tier I supplier. Then, the specifications are immediately taken into consideration for performing the suite of tests, and for generating the compliance certificates, for the specific type of component.

Thus, the present method and system for performing test compliance is dynamic, in the sense that the definition/modification of the specifications of a specific type of component manufactured by a tier I supplier, are taken into consideration in real time, for the generation of compliance certificates corresponding to components of this specific type. Furthermore, previously generated compliance certificates for this specific type of component may be updated in real time, and their compliance status modified, in accordance with an updated set of specifications. For example, the modified specifications may include an update of a measurable property (e.g. the tolerance threshold) of a compliance test (as illustrated in FIG. 3) of the compliance certificates corresponding to a specific type of component. In this case, for each compliance certificate corresponding to the specific type of component, the test status is re-evaluated. For this purpose, it is determined if the measured property is still in a range of values between the target value minus the updated tolerance threshold and the target value plus the updated tolerance threshold. It is not necessary to perform a new suite of tests to take into consideration the new specifications. The measured property obtained via a previously performed suite of tests is re-evaluated, by taking into consideration the value of the updated threshold. Then, the compliance status of the compliance certificate is re-evaluated, taking into consideration the updated test status corresponding to the updated tolerance threshold.

A product compliance data model may be generated and stored in the central database 401. The data model may represent a hierarchy of types of components (software, hardware parts, sub-systems) included in a type of product. A corresponding hierarchy of compliance certificates may be represented in the data model. And a hierarchy of suppliers involved in the manufacturing of the types of components may also be represented in the data model. Then, for each instance of a product, an instance of the hierarchy may be generated according to the data model; with the specific components, compliance certificates, and suppliers as needed.

The analytic system 403 may perform pre-calculations, in order to accelerate mathematical models assumption and identification of probable causes of issues and defects with product instances, over their life time. The pre-calculations are performed on various data of the compliance certificates, and more specifically on the measurable properties and the measured properties.

Additionally, the central database 401 and the analytic system 403 may be used, to identify statistical patterns that probabilistically determine the cause of a defect in a specific type of product. Further, actions and notifications may be triggered based on the context. And the analytic system 403 may also determine who should be identified as financially accountable, for the direct and indirect charges associated with the defective product units.

The statistical patterns are identified by analyzing the compliance certificates of the components included in a defective product; and more specifically the measurable properties and measured properties. For instance, the following statistical pattern may be identified: a specific (range of) value of one or several measured properties of a type of component, and the presence of a default in products using this type of component. The following statistical pattern may also be identified: a specific (range of) value of one or several measured properties of a first type of component, a specific (range of) value of one or several measured properties of a second type of component, and the presence of a default in products using the two types of components. Then, the central database 401 and the analytic system 403 may be used, to identify which other products have been using components with similar statistical patterns. This enables the proactive repair of delivered products, or the avoidance of assembling products including the identified components with the statistical patterns.

The central database 401 and the analytic system 403 may be further used to track all historical components (software, hardware parts, sub-systems, and products) ever produced and tested, whether they are compliant or defective; using the compliance certificates for this purpose. This tracking may be performed, in order to prevent the unauthorized commercial use of these components in secondary markets, which may be prohibited by contractual agreements. For example, the tracking prevents components reported as defective, to be repaired and sold, but reported to as scrapped. In another example, this tracking prevents components that were not sold to an OEM, to be purchased by a third party, in order to manufacture unauthorized products using the components, for the commercial benefit of the third party, and to the detriment of the OEM.

The central database 401 and the analytic system 403 may also be used to dynamically adapt the design of the components (software, hardware parts, sub-systems) of a product. Based on the test results included in the compliance certificates of a specific type of component, it may be determined that the design of this type of component is not appropriate. The design may then be modified, and corresponding modified specifications generated. These modified specifications are used for the generation of compliance certificates of components which integrate the modified design.

The compliance certificates may also be used to enforce IP rights corresponding to IP assets of IP owners (as represented in FIG. 1). For example, an IP owner may use the compliance certificates, to determine the exact number of compliant components manufactured by a supplier, which is licensing IP assets from the IP owner. For each compliant component (as determined per its compliance certificate), the IP owner is entitled to an IP fee paid by the supplier, based on IP rights negotiated between the IP owner and the supplier. Additionally, the specifications associated to the compliance certificates may be defined, so as to be compliant with the IP rights of the IP owner. Thus, a compliant component (as determined per its compliance certificate) respects the IP rights of the IP owner, further making the supplier bound to pay related IP fees to the IP owner.

The compliance certificates may also be used to implement a mechanism that leverages aggregated test results, in order to identify which organization in the product supply and value chains has supplied a defective part or sub-system. This mechanism enables service providers to identify defective product units supplied by OEMs, which were reported as compliant upon delivery, but which proved defective during the course of their warranty period. This mechanism also enables OEMs to identify defective parts (or sub-systems), supplied by a tier I supplier, which were reported as compliant upon delivery, but which proved defective during the course of their warranty period. Or to change the specifications of such parts (or sub-systems), in order to prevent the shipment of false-positive compliant products.

The compliance certificates may also be used to implement a mechanism that leverages aggregated test results, in order to account for how much test system time, and which other parts and sub-systems, were used in the production of a defective product unit. This mechanism enables the service provider to make the cost related to the production of the defective product unit accountable for, by the OEM and/or tier I supplier(s) responsible for this cost. Further, this mechanism enables the implementation of an automated discount and reimbursement policy, to the benefit of a downstream value chain member. And this mechanism also enables the implementation of a warranty charged-back system, by service providers with their OEMs, and by OEMs with their suppliers.

The central database (401 in FIG. 4) and the local databases (e.g. 411 and 421 in FIG. 4) may be implemented as a distributed scalable information database, which holds all the information related to product compliance. The distributed scalable information database comprises a set of similarly structured databases, holding complementary test data. The distribution of the test data is dictated by a set of rules, based on criteria such as location, product family, or product version. The distributed scalable information database also comprises a test data switch, which distributes test data to one or several databases, based on a set of user-defined rules. And the distributed scalable information database comprises a set of rules related to the life cycle management of test data. According to the set of rules, test data from one database are first stored as active, and usable for collaboration, process, and analytics purposes; before being archived or deleted from the database. A master database orchestrates the permanent availability of test data, ensuring that deleted information in one location is first secured at another location, before authorizing permanent deletion of such test data at any particular database instance.

Additionally, a mechanism may be implemented, by which supply chain users are not provided with privilege or access to resources that they are not allowed to have access to. And supply chain users are not allowed to generate or modify information affecting an information database, without the proper privileges.

A mechanism for end-user authentication and authorization may also be implemented. The mechanism supports a Single-Sign-On (SSO) architecture, where end-user authentication is performed against a Corporate Directory Infrastructure owned by each organization being part of the supply chain hierarchy. The mechanism is complemented with an authorization strategy, where a Hierarchical Policy Model is built on top of a Product Portfolio, allowing user group assignment independently of Individual's Corporation's Directory Service directives. A hierarchical Access Control Model allows the creation of a chain of access and responsibility, across large scale organizations and their suppliers. This Access control paradigm is based on the nature of the data, instead of simple user roles. The mechanism is composed of three components, required to fulfill the Federated Authentication/Authorization process. First, a Federated Directory service used to keep an operational record for each Individual involved in the Supply Chain; as well as for mapping-out Organizational Charts and Network Topology for each corporation involved in the Supply Chain. Then, Regional Authentication Front-Ends, which consist of proxies used to perform authentication of Individuals against their respective Corporate Directory Service. And finally, a Portfolio Configuration Registry, to maintain the Hierarchical Product Portfolio, and the Collaboration Policies attached to it.

A set of collaboration rules may also be implemented. According to these rules, access and privilege control is dictated by a set of supply chain and intra-organizational hierarchical rights assignments (divisions, departments, specific products, etc). The hierarchical rights assignments are combined to an Applicative Access Rights security model, which provides granular run-time usage of specific features of the hierarchical supply chain compliance infrastructure.

Although the present disclosure has been described in the foregoing description by way of illustrative embodiments thereof, these embodiments can be modified at will, within the scope of the appended claims without departing from the spirit and nature of the appended claims.

What is claimed is:

1. A method for performing dynamic test compliance in a multi level supply chain hierarchy, the method comprising:
receiving at a tier I supplier system specifications for a type of component;
allocating at the tier I supplier system a unique identifier to a component corresponding to the type of component;
executing at the tier I supplier system a suite of tests on the component;
generating at the tier I supplier system a compliance certificate for the component comprising the unique identifier of the component and a compliance status indicative of a compliance of the component, wherein the compliance status is a function of the specifications and results of the suite of tests; and
analyzing at an OEM system the compliance certificate of at least one component included in a product, using the unique identifier of the at least one component included in the product to identify the corresponding compliance certificate;
wherein the multi level supply chain hierarchy comprises the OEM and N levels of tier I suppliers, with N greater or equal to 1 and I varying from 1 to N.

2. The method of claim 1, wherein the compliance certificate comprises measurable properties corresponding to the specifications, and measured properties corresponding to the results of the suite of tests; wherein each measured property is associated to a corresponding measurable property.

3. The method of claim 2, wherein the compliance status of the compliance certificate is generated as a function of a value of each measured property being within a set of values defined by the corresponding measurable property.

4. The method of claim 3, wherein a measurable property comprises a target value and a tolerance threshold; and the set of values defined by the corresponding measurable property are a range of values between the target value minus the tolerance threshold and the target value plus the tolerance threshold.

5. The method of claim 4, wherein the compliance status of the compliance certificate is compliant when the value of each measured property is in a range of values between the target value minus the tolerance threshold and the target value plus the tolerance threshold.

6. The method of claim 3, wherein at least one measurable property is modified, and the compliance status of the compliance certificate is re-evaluated to take into account the modification to the measurable property.

7. The method of claim 1, wherein the OEM manufactures products which may include components from at least one tier 1 supplier; and a tier I supplier manufactures components which may include components from at least one tier I+1 supplier.

8. The method of claim 1, wherein the type of component comprises one of: a software, a hardware part, and a sub-system.

9. The method of claim 1, wherein analyzing the compliance certificate of at least one component included in a product consists in analyzing the compliance certificates of all the components included in a product, to determine which components have a compliance certificate with a compliance status set to non compliant.

10. The method of claim 1, wherein analyzing the compliance certificate of at least one component included in a product consists in identifying statistical patterns in compliance certificates of components included in defective products, and further identifying other products using components with similar statistical patterns in their compliance certificates.

11. A system for performing dynamic test compliance in a multi level supply chain hierarchy, the system comprising:
a tier I supplier system for:
receiving specifications for a type of component;
allocating a unique identifier to a component corresponding to the type of component;
executing a suite of tests on the component; and
generating a compliance certificate for the component comprising the unique identifier of the component and a compliance status indicative of a compliance of the component, wherein the compliance status is a function of the specifications and results of the suite of tests; and
an OEM system for:
analyzing the compliance certificate of at least one component included in a product, using the unique identifier of the at least one component included in the product to identify the corresponding compliance certificate;
wherein the multi level supply chain hierarchy comprises the OEM and N levels of tier I suppliers, with N greater or equal to 1 and I varying from 1 to N.

12. The system of claim 11, wherein the compliance certificate comprises measurable properties corresponding to the specifications, and measured properties corresponding to the results of the suite of tests; wherein each measured property is associated to a corresponding measurable property.

13. The system of claim 12, wherein the compliance status of the compliance certificate is generated as a function of a value of each measured property being within a set of values defined by the corresponding measurable property.

14. The system of claim 13, wherein a measurable property comprises a target value and a tolerance threshold; and the set of values defined by the corresponding measurable property are a range of values between the target value minus the tolerance threshold and the target value plus the tolerance threshold.

15. The system of claim 14, wherein the compliance status of the compliance certificate is compliant when the value of each measured property is in a range of values between the target value minus the tolerance threshold and the target value plus the tolerance threshold.

16. The system of claim 13, wherein at least one measurable property is modified, and the compliance status of the compliance certificate is re-evaluated to take into account the modification to the measurable property.

17. The system of claim 11, wherein the OEM manufactures products which may include components from at least one tier 1 supplier; and a tier I supplier manufactures components which may include components from at least one tier I+1 supplier.

18. The system of claim 11, wherein the type of component comprises one of: a software, a hardware part, and a sub-system.

19. The system of claim 11, wherein analyzing the compliance certificate of at least one component included in a product consists in analyzing the compliance certificates of all the components included in a product, to determine which components have a compliance certificate with a compliance status set to non compliant.

20. The system of claim 11, wherein analyzing the compliance certificate of at least one component included in a product consists in identifying statistical patterns in compliance certificates of components included in defective products, and further identifying other products using components with similar statistical patterns in their compliance certificates.
